(19) United States
(12) Patent Application Publication
(10) Pub. No.: US 2022/0410446 A1
(43) Pub. Date: Dec. 29, 2022

(54) MACHINE FOR PRODUCING A FOAM-IN-BAG DUNNAGE MATERIAL

(71) Applicant: Storopack Hans Reichenecker GMBH, Metzingen (DE)

(72) Inventors: Dante Olmi, Sassuolo (IT); Marco Corradi, Reggio Nell'Emilia (IT)

(21) Appl. No.: 17/806,542

(22) Filed: Jun. 13, 2022

(30) Foreign Application Priority Data
Jun. 25, 2021 (EP) 21 181 875.2-1017

(51) Int. Cl. B29C 44/18; B29C 44/34; B01F 33/501

(52) U.S. Cl. CPC B29C 44/182; B29C 44/3442; B01F 33/5014; B29K 2105/04

(57) ABSTRACT

A machine for producing a foam-in-bag dunnage material comprises first and second foam precursor inlets for first and second foam precursor substances, a first mixing chamber for mixing the first and second foam precursor substances into a first mixture, and a first dispenser for dispensing the first mixture. It is proposed that the machine comprises a branch-off-device fluidly arranged between the first and second foam precursor inlets and the first mixing chamber and having first and second foam precursor outlets towards the first mixing chamber and third and fourth foam precursor outlets towards an interface device, the interface device being adapted to fluidly connect to a second mixing chamber for mixing the first and second foam precursor substances into a second mixture.

The present invention relates to a machine for producing a foam-in-bag dunnage material according to the preamble of claim 1.

Foam-in-bag dunnage material is known as a technology where a mixture of a plurality of liquid chemical foam precursor substances is injected into a plastic bag. The liquid chemical foam precursor substances react with each other in the mixture by expanding and building a rather low density foam which, after expansion, hardens. This hardened foam may fill a void volume in a container between the container walls and an article placed inside the container, thus blocking the articles inside the container from moving around and also providing a protecting function against shock movements. EP 2 480 393 B1 discloses a machine for producing a foam-in-bag dunnage material.

It is an object of the present invention to provide a machine for producing a foam-in-bag dunnage material being more flexible to use.

According to the invention this object is solved by a machine for producing a foam-in-bag dunnage material with the features of claim 1. Further embodiments of the invention are given in the dependent claims.

A major advantage of the invention is that the inventive machine allows to have two separate mixing chambers, which are supplied with the same foam precursor substances from the same foam precursor supplies, which allows to produce first and second mixtures at first and second locations with one machine and, if desired, at the same time, and/or to produce first and second mixtures having different properties with one machine and, if desired, at the same time, and/or to produce first and second mixtures by way of different operating principles, for example automatically/semi-automatically and manually. The inventive machine therefore can be adapted easily to the specific application needs of a specific packaging environment. With the inventive machine a number of important functional elements can be shared for the production of the first and second mixtures, which reduces the costs compared to two separate machines.

More specifically, the inventive machine for producing a foam-in-bag dunnage material comprises first and second foam precursor inlets for first and second foam precursor substances. These inlets may be formed in an interface device, and they may be formed for example as releasable fluid connectors. The first and second foam precursor substances may be liquid. Examples for such foam precursor substances are Isocyanate and Polyol.

The inventive machine further comprises a first mixing chamber for mixing the first and second foam precursor substances into a first mixture, the first mixing chamber being fluidly connected to the first and second foam precursor inlets. A first dispenser is fluidly connected to the first mixing chamber, and in most cases will be arranged directly adjacent to the first mixing chamber. The reason is that when the first and second foam precursor substances are mixed to the first mixture, the substances immediately start to react with each other such that gas bubbles are created. It is therefore advantageous if the first mixture is dispensed immediately after being created.

The machine comprises a branch-off-device fluidly arranged upstream of the first mixing chamber, preferably between the first and second foam precursor inlets and the first mixing chamber. This branch-off-device serves functionally as a fluid divider allowing the first and second foam precursor substances to flow into at least two different fluid branches. The flow divider may be a manifold without control on how to divide the stream. For this purpose, the branch-off-device comprises first and second foam precursor outlets towards the first mixing chamber and third and fourth foam precursor outlets towards a second mixing chamber, preferably towards an interface device being adapted to fluidly connect to the second mixing chamber. While the first and third foam precursor outputs are in fluid connection with the first foam precursor inlet, the second and fourth foam precursor outputs are in fluid connection with the second foam precursor inlet. Typically, the branch-off-device comprises two Y-connectors.

The interface device which is fluidly connected to the third and fourth foam precursor outputs is adapted to fluidly connect to a second mixing chamber for mixing the first and second foam precursor substances into a second mixture. As has been mentioned above, this second mixing chamber may be arranged at a different location than the first mixing chamber, may be structured differently than the first mixing chamber such that the second mixture is different than the first mixture, or may be used according to an operation principle which is different from the operation principle of the first mixing chamber.

In a further embodiment, the first dispenser is fixedly connected to a frame of the machine, and the machine comprises a bag supply for supplying a bag to a position close to the first dispenser, the first dispenser being adapted to automatically dispense the first mixture into the bag, if desired. Such an arrangement is typical for the automatic or semi-automatic and stationary production of bags, which are then removed from the machine manually by a user and moved to a packaging site, where a bag may be placed manually into a container. The first mixture then may further expand and hereby gradually fill the void between an article and an inner wall of the container and finally at least partially conform to the shape of the article to be packaged. Preferably, the machine comprises a sealing means which automatically seals the bag filled with the first mixture prior to being grasped by a user and moved to the packaging site.

In a further embodiment, the machine comprises a handheld dispensing assembly comprising the second mixing chamber. Such an arrangement is typical for the “manual” production of foam-in-place dunnage material. For example, the empty bag may be arranged in the container, and then the handheld dispensing assembly may be moved manually by user to a fill opening of the bag. Thereafter, a quantity of the second mixture may be filled into the bag corresponding to the individual geometric situation, in particular depending on the size and/or the shape of the void to be filled, as desired by a user. Another typical application of an handheld dispensing assembly is to dispense the foam directly into the container, where the item to be packed has been previously enveloped in a protective film.

In a further embodiment thereto, the handheld dispensing assembly comprises an activating device to be manually operated by a user for dispensing the second mixture. This allows a user to individually and situationally control the amount of the second mixture dispensed by the dispensing device.

In a further embodiment, the machine comprises a controller for at least temporarily controlling at least some aspects of the operation of the machine. This provides for a smart, safe and efficient operation of the machine. The controller may comprise a microprocessor and a data storage for storing program code to be executed by the microprocessor. By way of example, the controller may be or comprise a computer.

In a further embodiment, the controller may be programmed such that the machine can be operated either only with the first mixing chamber or simultaneously with the first and the second mixing chamber, or the controller may be programmed such that the machine can be operated either only with the second mixing chamber or simultaneously with the first and the second mixing chamber, or the controller may be programmed such that the machine can be operated either only with the first mixing chamber or only with the second mixing chamber or simultaneously with the first and the second mixing chamber. Typically, the controller may control the amount and the relation of quantities of first and second foam precursor substances pumped to the first and second foam precursor inlets. The possibility to either manually or automatically select different modes of operation, the amount of first and second foam precursor substances, and the relation of quantities of the first and second foam precursor substances allows to precisely control the operation according to the specific needs of the packaging situation.

In a further embodiment, the machine comprises an input means for inputting commands to the controller by a user. This allows a user for example to easily input the desired mode of operation and/or other data, such as for example the amount of first and/or second mixture to be dispensed by the first dispenser and/or the handheld dispensing assembly. It is to be understood that different input means may be used, such as a keyboard, a touchscreen, a microphone for inputting acoustic information, such as speech, and/or a camera for inputting gestures.

In a further embodiment, the machine comprises an output means for outputting information to a user. This allows a user for example to observe an actual condition of the machine, such as machine settings, mode of operation, quantity of foam precursor substances still available, and so on. The output means preferably comprises a display, but may also comprise other optical indicators, or may comprise an acoustic output means, such as a loudspeaker, for outputting signals and/or speech.

In a further embodiment, the interface device comprises an electrical connecting device for electrically connecting the handheld dispensing assembly to the controller and/or an energy supply. This allows the easy connection of the handheld dispenser assembly to the controller and/or energy supply, especially an electrical power supply. By consequence, the handheld dispenser may be a “smart” and/or “intelligent” dispenser. It is to be understood that the connection to the controller may be made by means of a wire connector, but may also be made by means of wireless data transfer, such as Bluetooth are Wi-Fi or the like.

In a further embodiment, the machine comprises first and second foam precursor supply lines fluidly arranged between the first and second foam precursor inlets and first and second foam precursor supplies, and a heating device for heating the first and second foam precursor substances contained within the first and second foam precursor supply lines. In a further embodiment, the machine comprises third and fourth foam precursor supply lines fluidly arranged between the interface and the second mixing chamber, and a heating device for heating the third and fourth foam precursor substances contained within the third and fourth foam precursor supply lines.

The mentioned heating devices provide for the correct viscosity of the foam precursor substances by heating the foam precursor substances to an appropriate temperature, typically to 50-80° C. In order to provide a desired temperature, one or more temperature sensors may be arranged in the foam precursor supply lines and be connected to a temperature controller, which controls the heating device and/or devices. The foam precursor supply lines may be formed for example by flexible hoses, independent from whether they are equipped with the heating devices or not.

In a further embodiment, the interface device is adapted to releasably fluidly connect to the third and fourth supply lines. This allows the machine according to the invention to be operated easily with or without the second mixing chamber, and also allows for example to easily exchange a specific handheld dispenser assembly against a different specific handheld dispenser assembly.

In a further embodiment, the interface device comprises closure means to releasably and fluid tightly close the interface device when the machine is operated without the third and fourth foam precursor supply lines being connected. Such closure means may be, for example, a simple screw cap for closing the fluid connectors, but also may be for example a valve which may be operated automatically by the controller when it is detected that the third and fourth foam precursor supply lines are removed or which may be operated manually by the user prior to removing the third and fourth foam precursor supply lines. The mentioned closure means increases the operational safety of the machine.

In a further embodiment, the branch-off-device and the interface device are comprised in a common housing. This reduces the size of the machine and allows even to retrofit already existing machines with the technology according to the invention.

It is to be noted that in the present context the terms “first, second, third, and fourth” are not to be understood in a limiting way or as a firm sequence, but rather and simply are used in order to distinguish functionally similar but separate elements and/or regions from each other. It is also to be understood that it is within the scope of the present invention that “fifth, sixth, and so on” functionally similar elements and/or regions may be present or that only third and fourth elements may be present.

The features and the advantages of the invention will be evident from the following description, regarding particular embodiments thereof, which is made as a non-limiting example with reference to the attached drawings, wherein:

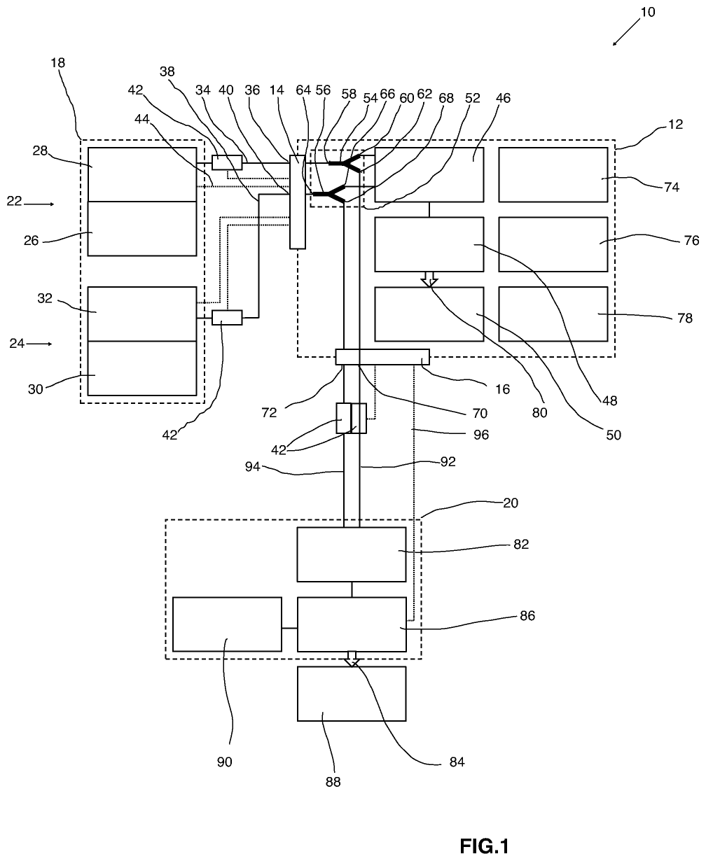

FIG. 1 is a functional block diagram representing functional elements of a machine for producing a foam-in-bag dunnage material in a first operating condition;

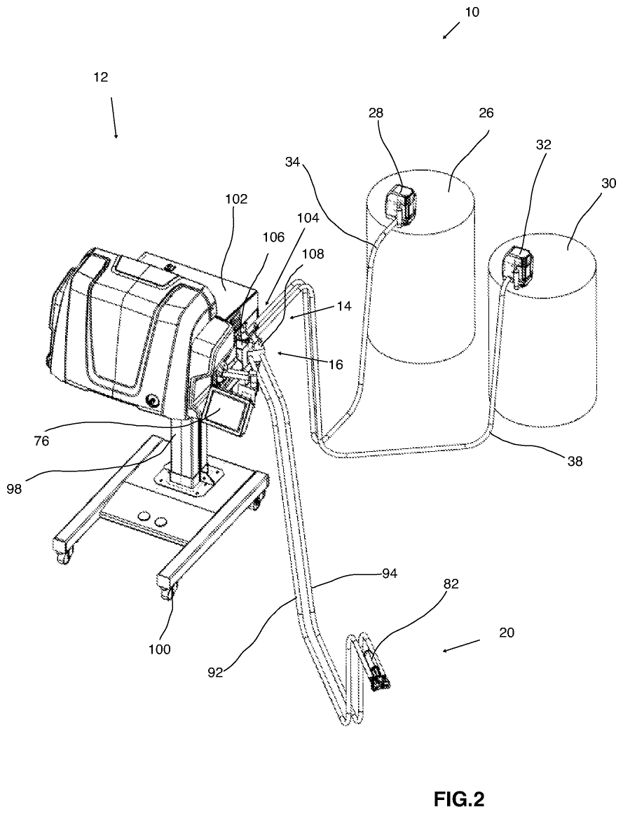

FIG. 2 is a perspective view of the machine of FIG. 1 in the first operating condition;

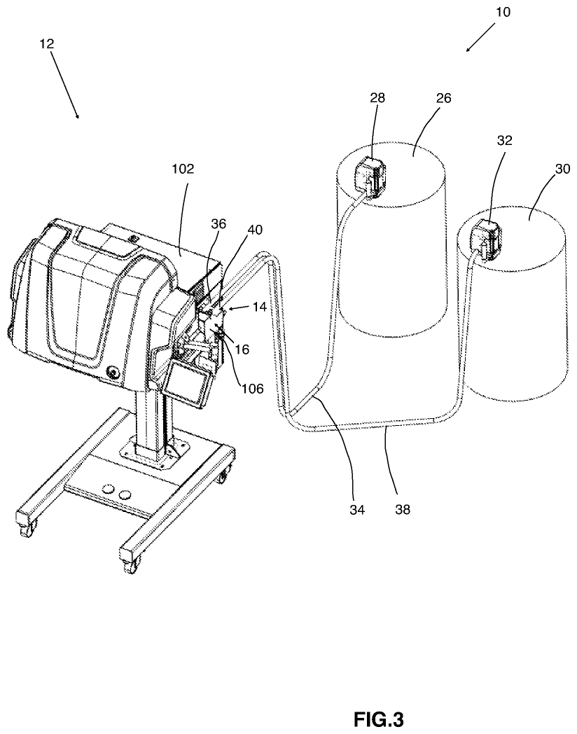

FIG. 3 is a perspective view similar to FIG. 2, the machine being in a second operating condition;

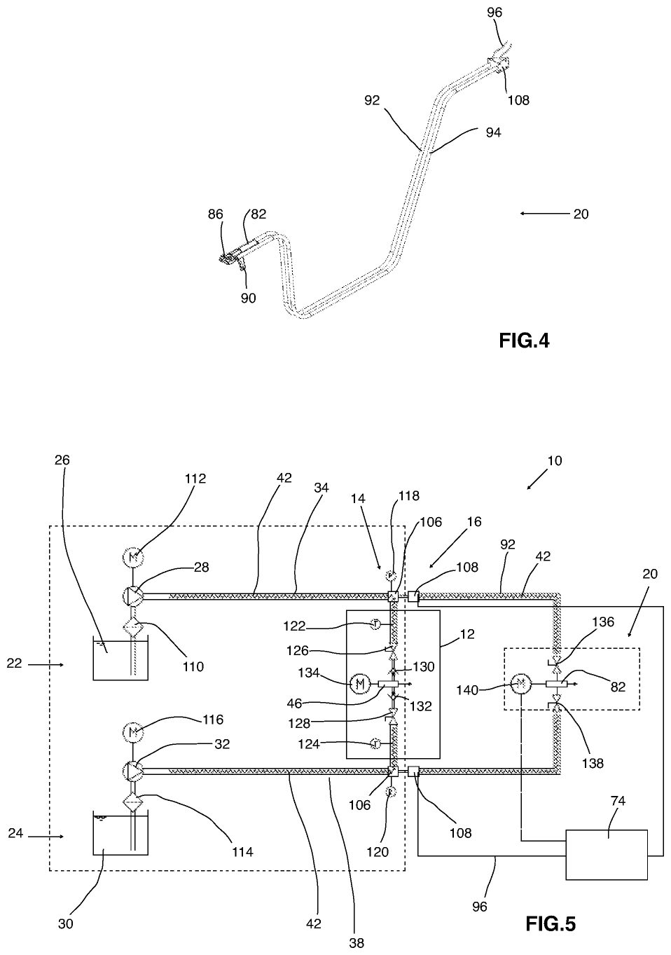

FIG. 4 is a perspective view of a handheld dispensing assembly as used in the machine of FIGS. 1 and 2; and

FIG. 5 is a hydraulic functional representation of the machine of FIGS. 1-3.

In the following detailed description and the attached figures functionally equivalent elements and regions may be designated with identical reference signs. Furthermore, for the sake of clarity in the figures not always all reference signs are drawn.

In the figures, a machine for producing a foam-in-bag dunnage material is generally designated with reference numeral 10. It comprises a main arrangement 12. The main arrangement 12 comprises a first interface 14 and a second interface 16.

The machine 10 further comprises a foam precursor supply arrangement 18, which is fluidly connected to the first interface 14, as will be described in more detail further below. Moreover, the machine 10 comprises a handheld dispensing assembly 20, which is fluidly connected to the second interface 16, as will be described in more detail further below.

The foam precursor supply arrangement 18 comprises a first foam precursor supply 22 and a second foam precursor supply 24. The first foam precursor supply 22 comprises a first foam precursor tank 26 and a first foam precursor pump 28. The second foam precursor supply 24 comprises a second foam precursor tank 30 and a second foam precursor pump 32. The first foam precursor tank 26 may be filled with a first foam precursor substance, such as Isocyanate. The second foam precursor tank 30 may be filled with a second foam precursor substance, such as Polyol. Both foam precursor tanks 26 and 30 may be formed for example by respective cylindrical drums.

The machine 10 further comprises a first foam precursor supply line 34 which connects an outlet of the first foam precursor pump 28 to a first foam precursor inlet 36 of the first interface 14. Similarly, the machine 10 comprises a second foam precursor supply line 38 which connects an outlet of the second foam precursor pump 32 to a second foam precursor inlet 40 of the first interface 14. Heating devices 42 are provided in both foam precursor supply lines 34 and 38 for heating the first and second foam precursor substances contained within the first and second foam precursor supply lines 34 and 38. As is shown by dotted lines 44 in FIG. 1, the foam precursor pumps 28 and 32 and the heating devices 42 are also electrically connected to the first interface 14.

The main arrangement 12 of the machine 10 comprises a first mixing chamber 46 for mixing the first and second foam precursor substances into a first mixture, and a first dispenser 48 for dispensing the first mixture into a bag 50. Moreover, the main arrangement 12 comprises a branch-off-device 52 which is fluidly arranged between the first and second foam precursor inlets 36 and 40 and the first mixing chamber 46. The branch-off-device 52 comprises a first Y-channel-arrangement 54 and a second Y-channel-arrangement 56. The first Y-channel-arrangement 54 comprises a first fluid inlet 58 and first and third foam precursor outlets 60 and 62. The second Y-channel-arrangement 56 comprises a second fluid inlet 64 and second and fourth foam precursor outlets 66 and 68.

The first fluid inlet 58 is fluidly connected to the first foam precursor inlet 36. The second fluid inlet 64 is fluidly connected to the second foam precursor inlet 40. The first and second foam precursor outlets 60 and 66 are fluidly connected to the first mixing chamber 46. The third and fourth foam precursor outlets 62 and 68 are fluidly connected to first and second fluid connectors 70 and 72 of the second interface device 16.

The main arrangement 12 of the machine 10 further comprises a controller 74 for controlling at least some aspects of the operation of the machine 10 as well as a combined inputting and outputting means 76 for inputting commands and/or data to the controller 74 and for outputting information to a user. Typically, the controller 74 comprises a microprocessor and a storage means for storing program code which may be executed by the microprocessor. The controller 74 may comprise or be a computer. The combined inputting and outputting means 76 in the present exemplary embodiment is a touchscreen. However, many other types of inputting and/are outputting means may be used, such as a keyboard, a microphone, a loudspeaker, et cetera.

Furthermore, the main arrangement 12 comprises a bag supply 78 which may automatically provide a plastic bag 50 to a position close to the first dispenser 48 when requested by a user such that the first dispenser 48 may dispense automatically or on demand by a user the first mixture (arrow 80 in FIG. 1) into the plastic bag 50.

The handheld dispensing assembly 20 comprises a second mixing chamber 82 for mixing the first and second foam precursor substances into a second mixture (arrow 84 in FIG. 1). It further comprises a second dispenser 86 for dispensing the second mixture 84 into a bag 88. The handheld dispensing assembly 20 also comprises an activating device 90 to be manually operated by a user for dispensing the second mixture 84. The handheld dispensing assembly 20 is fluidly connected to the second interface device 16 by means of third and fourth foam precursor supply lines 92 and 94 which are fluidly arranged between the second interface device 16 and the second mixing chamber 82.

A heating device 42 is arranged in the third and fourth foam precursor supply lines 92 and 94 for heating the first and second foam precursor substances contained within the third and fourth foam precursor supply lines 92 and 94. The second interface device 16 is adapted to releasably fluidly connect to the third and fourth foam precursor supply lines 92 and 94. As indicated by dotted lines 96 in FIG. 1, the handheld dispensing assembly 20 is also releasably electrically connected to the second interface device 16. For this purpose, the second interface device 16 comprises a connecting device (not shown) for electrically connecting the handheld dispensing assembly 20 to the controller 74 and/or an electrical energy supply (not shown). In a preferred embodiment, the fluid connection and the electrical connection from the handheld dispensing assembly 22 to the second interface device 16 may be made simultaneously by means of a combined fluid and electrical connecting device.

The second interface device 16 comprises closure means (not shown) to selectively and fluid tightly close the second interface device 16 when the machine 10 is operated without the third and fourth foam precursor supply lines 92 and 94 being connected. The closure means may be formed by a screw cap or by a valve which may be operated automatically by the controller 74 when the controller 74 detects that the handheld dispensing assembly 20 is removed, or manually by a user.

As has been mentioned, the controller 74 may be programmed in order to control at least temporarily and at least aspects of the operation of the machine 10. For this purpose, the controller 74 may be programmed in different ways:

According to a first aspect, the controller 74 may be programmed such that the machine 10 can be operated either only with the first mixing chamber 46 and the first dispenser 48 in order to dispense the first mixture 80 into a bag 50, or simultaneously with the first mixing chamber 46 as described above and additionally with the second mixing chamber 82 of the handheld dispensing assembly 20, in order to additionally dispense the second mixture 84 by means of the second dispenser 86 into a bag 88, which might for example be arranged already within a container.

According to a second aspect, the controller 74 may be programmed such that the machine 10 can be operated either only with the second mixing chamber 82 as described above or simultaneously with the first mixing chamber 46 and the second mixing chamber 82, both as described above.

According to a third aspect, the controller 74 may be programmed such that the machine 10 can be operated either only with the first mixing chamber 46 as described above or only with the second mixing chamber 82 as described above or simultaneously with the first mixing chamber 46 and the second mixing chamber 82 as described above.

As can be seen from FIG. 2, the machine 10 comprises a stand 98 which is movable on rollers 100. A frame 102 is attached to the stand 98, the frame 102 fixedly supporting the main arrangement 12. In the specific embodiment of FIGS. 2 and 3, the branch-off-device 52 and the second interface device 16 are comprised in a common housing 104 which is arranged at a lateral portion of the frame 102 and the main arrangement 12.

Preferably, the common housing 104 comprises two manifold blocks 106 and 108. The first manifold block 106 is adapted to connect the first and second foam precursor supply lines 34 and 38 as well as the electrical connection to the heating devices 42, the foam precursor pumps 28 and 32, and so on. Moreover, first manifold block 106 comprises the first and second Y-channel-arrangements 54 and 56 which, in the present exemplary embodiment, may be formed by channels within the first manifold block 106. First manifold block 106 is fixedly mechanically connected to the frame 102 and is also fixedly fluidly connected to the first mixing chamber 46. Its outer lateral area serves as the second interface device 16, while its rear area (in FIGS. 2 and 3) serves as the first interface 14.

The second manifold block 108 is mechanically and fluidly fixedly connected to the third and fourth foam precursor supply lines 92 and 94 of the handheld dispensing assembly 20, as can been seen from FIG. 4 which shows solely the handheld dispensing assembly 20 and the components belonging thereto. The second manifold block 108 may be mechanically, fluidly and electrically attached/connected to the first manifold block 106 in case that the machine 10 is to be operated together with the handheld dispensing assembly 20.

FIG. 2 shows the machine 10 in a first operating condition with the handheld dispensing assembly 20 and its second mixing chamber 82 connected to the second interface device 16. FIG. 3 shows the machine 10 in a second operating condition without the handheld dispensing assembly 20 being connected.

Now the hydraulic principles of the machine 10 will be explained with reference to FIG. 5. FIG. 5 shows the machine 10 in the first operating condition together with the handheld dispensing assembly 20.

The first foam precursor supply 22 comprises the first foam precursor tank 26, a first filter screen 110, and the first foam precursor pump 28, which may be driven by a first pump motor 112. Similarly, the second foam precursor supply 24 comprises the second foam precursor tank 30, a second filter screen 114, and the second foam precursor pump 32, which may be driven by a second pump motor 116.

Within the first manifold block 106, there are provided a first pressure sensor 118 and a second pressure sensor 120 for detecting the liquid pressure of the first and second foam precursor substances. Furthermore, downstream of the first manifold block 106 towards the first mixing chamber 46, there are provided a first temperature sensor 122 and a second temperature sensor 124 for detecting the temperature of the first and second foam precursor substances contained with the first and second foam precursor supply lines 34 and 38. The signals of the sensors 118-124 are provided to the controller 74 which provides appropriate control signals to the pump motors 112 and 116 and the heating devices 42.

Downstream of the first manifold block 106 are provided first and second manually operated valves 126 and 128 as well as check valves 130 and 132. A first dispenser motor 134 is arranged at the first mixing chamber 46 and activated either automatically by the controller 74 or manually/semi-automatically based on an input of the user at the touchscreen 76 in order to dispense the first mixture 18 into the bag 50 (FIG. 1).

As can be seen from FIG. 5, the second manifold block 108 is mechanically and fluidly as well as electrically connected to the first manifold block 106. The handheld dispensing assembly 20 comprises third and fourth manually operated valves 136 and 138, which are arranged in the respective third and fourth foam precursor supply lines 92 and 94 close to the second mixing chamber 82. A second dispenser motor 140 is arranged at the second mixing chamber 82 and manually activated by means of the activating device 90 shown in FIG. 1 in order to dispense the second mixture 84 into the bag 88 (FIG. 1).

1. Machine for producing a foam-in-bag dunnage material, comprising first and second foam precursor inlets for first and second foam precursor substances, a first mixing chamber for mixing the first and second foam precursor substances into a first mixture, and a first dispenser for dispensing the first mixture, wherein the machine comprises a branch-off-device fluidly arranged upstream of the first mixing chamber and having first and second foam precursor outlets towards the first mixing chamber and third and fourth foam precursor outlets towards a second mixing chamber for mixing the first and second foam precursor substances into a second mixture.

2. The machine of claim 1, wherein the first dispenser is fixedly connected to a frame of the machine, and wherein the machine comprises a bag supply for supplying a bag to a position close to the first dispenser, the first dispenser being adapted to dispense the first mixture into the bag.

3. The machine of claim 1, wherein it comprises a handheld dispensing assembly comprising the second mixing chamber.

4. The machine of claim 3, wherein the handheld dispensing assembly comprises an activating device to be manually operated by a user for dispensing the second mixture.

5. The machine of claim 1, wherein it comprises a controller for at least temporarily controlling an operation of the machine.

6. The machine of claim 5, wherein the controller is programmed such that the machine can be operated either only with the first mixing chamber or simultaneously with the first and the second mixing chamber, or the controller being programmed such that the machine can be operated either only with the second mixing chamber or simultaneously with the first and the second mixing chamber, or the controller being programmed such that the machine can be operated either only with the first mixing chamber or only with the second mixing chamber or simultaneously with the first and the second mixing chamber.

7. The machine of claim 5, wherein it comprises an input means for inputting commands to the controller by a user.

8. The machine of claim 5, wherein it comprises an output means for outputting information to a user.

9. The machine of claim 5, wherein the interface device comprises an connecting device for electrically connecting the handheld dispensing assembly to the controller and/or an energy supply.

10. The machine of claim 1, wherein it comprises first and second foam precursor supply lines fluidly arranged between the first and second foam precursor inlets and first and second foam precursor supplies, and a heating device for heating the first and second foam precursor substances contained within the first and second foam precursor supply lines.

11. The machine of claim 1, wherein it comprises third and fourth foam precursor supply lines fluidly arranged between the interface and the second mixing chamber, and a heating device for heating the first and second foam precursor substances contained within the third and fourth foam precursor supply lines.

12. The machine of claim 11, wherein the interface device is adapted to releasably fluidly connect to the third and fourth supply lines.

13. The machine of claim 12, wherein it comprises closure means to releasably and fluid tightly close the interface device when the machine is operated without the third and fourth foam precursor supply lines being connected.

14. The machine of claim 1, wherein the branch-off-device and the interface device are comprised in a common housing).
